(19) United States
(12) Patent Application Publication
(10) Pub. No.: US 2022/0091844 A1
(43) Pub. Date: Mar. 24, 2022

(54) SYSTEM FOR ACHIEVING INSIGHTS THROUGH INTERACTIVE FACET-BASED ARCHITECTURE RECOVERY (I-FAR)

(71) Applicant: Drexel University, Philadelphia, PA (US)

(72) Inventors: Yuanfang Cai, Paoli, PA (US); Frederick Kazman, Pittsburgh, PA (US); Hongzhou Fang, Philadelphia, PA (US)

(73) Assignee: Drexel University, Philadelphia, PA (US)

(21) Appl. No.: 17/391,186

(22) Filed: Aug. 2, 2021

Related U.S. Application Data
(60) Provisional application No. 63/060,081, filed on Aug. 2, 2020.

(51) Int. Cl. G06F 8/75; G06F 8/74; G06F 8/41

(52) U.S. Cl. CPC G06F 8/75; G06F 8/433; G06F 8/74

(57) ABSTRACT

The method and system is called I-FAR: Interactive, Facet-based Architecture Recovery. Inspired by the idea that each system feature, pattern, or concern may have its own design space, the method defines a “facet” as a set of files that have one primary purpose, such as the implementation of a feature or the management of a cross-cutting concern such as performance, security, logging, etc.

### STATEMENT REGARDING GOVERNMENT SUPPORT

This invention was made with government support under Contract No. E-AR0001114 awarded by the Advanced Research Projects Agency. The government has certain rights in the invention.

### BACKGROUND

It may be difficult to learn the structure of a large software system with many files, complex dependencies, and invariably out-of-date (or no) documentation. The developers of the system may have a deep understanding of the parts they work on but may lack the knowledge of other parts or the big picture. Architectural drift and erosion, caused by normal development activities, uninformed modifications, and undocumented or forgotten design decisions, make it even more difficult to understand and maintain the evolving architecture.

To help developers better understand the software architecture, several architecture recovery methods have been created based on various rationales. These include: Bunch, Algorithm for Comprehension-Driven Clustering (ACDC), scaLable InforMation Bottleneck (LIMBO), Weighted Combined Algorithm (WCA), Architecture Recovery using Concerns (ARC), and a zone-based clustering technique. These techniques rely on two kinds of input that can be obtained from source code: textual info from words used in the code, and the dependency relations extracted from source entities.

The adoption of these architecture recovery methods in practice has been limited. These methods all assume that a system can be split into file clusters that are mutually exclusive, each representing one “module,” along with relationships between each module. In practice, this seldom works. For large systems, there are invariably many clusters with complex dependencies that obscure the system architecture. Moreover, from a functional perspective, a file often serves multiple functions or features, and file-groups related to functions are seldom mutually exclusive. Another challenge is that, even though it is possible to retrieve a “ground-truth” architecture at a point of time, the software continuously evolves and changes, ground-truth today may not be ground-truth tomorrow.

### SUMMARY OF THE EMBODIMENTS

To address these problems, the inventors have created I-FAR: Interactive, Facet-based Architecture Recovery. Inspired by the idea that each system feature, pattern, or concern may have its own design space, the inventors define a “facet” as a set of files that have one primary purpose, such as the implementation of a feature or the management of a cross-cutting concern such as performance, security, logging, etc.

Based on the notion that only the system's stakeholders can specify which facets they care to investigate or maintain, the inventors explored the possibility of recovering facet-related design interactively, that is, including a user's selection of facets as part of I-FAR.

The system aids the understanding of a system's architecture through the lens of features, concerns, or other facets of interest that may, in turn, aid maintenance and evolution. The inventors achieve this goal by helping developers: 1) understand the design related to selected facets, 2) understand the core data model and the uses hierarchy behind these facets, 3) understand how a cross-cutting concern of a system, such as performance or security, influences features, and 4) understand why facets may be unexpectedly coupled.

Using I-FAR, the inventors have conducted case studies with 8 projects: 2 with open source projects and 6 industrial projects. The architects of those systems have confirmed that the facet-specific design structures recovered by I-FAR provide unique views that are valuable in understanding the underlying design and in facilitating future maintenance tasks, such as adding new features or assessing change impact. Most interestingly, I-FAR helped architects detect subtle design problems that couple features unexpectedly, incurring design debts that are not detectable by other tools. These results suggest new directions for more effective architecture recovery methods that can directly support software evolution and prevent design debts from accumulating and causing severe damages.

### BRIEF DESCRIPTION OF THE DRAWINGS

FIG. 1A shows an embodiment of a network environment.

FIG. 1B shows block diagrams of a computing device;

FIG. 2 depicts a partial UML class diagram of a small questionnaire management system.

FIG. 3 depicts the uses hierarchy: each node is a function group, i.e, a set of files, and the edges model the “uses” relation among them.

FIG. 4 shows a working prototype2 that enables the user to interactively choose the keywords that best reflect their facets of interest.

FIG. 5 shows a hierarchical graph.

FIG. 6 shows a different prototype design.

FIG. 7 depicts the three major stages of the method and system approach: 1) source code processing, 2) uses hierarchy calculation, and 3) facet calculation.

FIG. 8 shows a sample .csv file in which the architect of Depends listed the facets and marked corresponding keywords.

FIG. 9 and FIG. 10 depicts two facet clusterings calculated from Depends' 3 exporting functions and 4 language processing functions respectively.

FIGS. 11A, 11B, and 11C show different pseudocode.

FIG. 12 shows Table 1.

### DETAILED DESCRIPTION OF THE EMBODIMENTS

### 1. Introduction

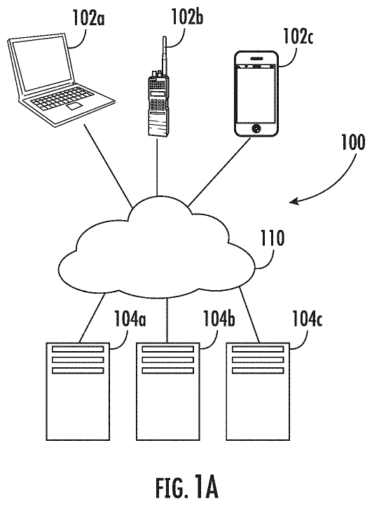

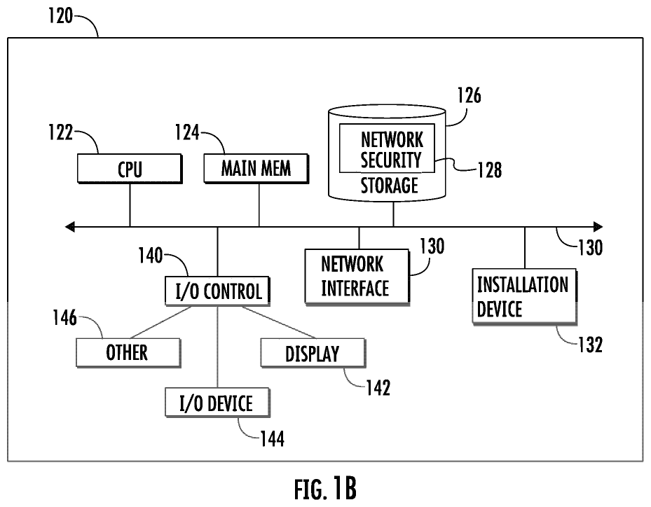

The system and method using the system and method described herein may be implemented using system and hardware elements shown and described herein. For example, FIG. 1A shows an embodiment of a network 100 with one or more clients 102a, 102b, 102c that may be local machines, personal computers, mobile devices, servers, tablets that communicate through one or more networks 110 with servers 104a, 104b, 104c. It should be appreciated that a client 102a-102c may serve as a client seeking access to resources provided by a server and/or as a server providing access to other clients.

The network 110 may be wired or wireless links. If it is wired, the network may include coaxial cable, twisted pair lines, USB cabling, or optical lines. The wireless network may operate using BLUETOOTH, Wi-Fi, Worldwide Interoperability for Microwave Access (WiMAX), infrared, or satellite networks. The wireless links may also include any cellular network standards used to communicate among mobile devices including the many standards prepared by the International Telecommunication Union such as 3G, 4G, and LTE. Cellular network standards may include GSM, GPRS, LTE, WiMAX, and WiMAX-Advanced. Cellular network standards may use various channel communications such as FDMA, TDMA, CDMA, or SDMA. The various networks may be used individually or in an interconnected way and are thus depicted as shown in FIG. 1A as a cloud.

The network 110 may be located across many geographies and may have a topology organized as point-to-point, bus, star, ring, mesh, or tree. The network 110 may be an overlay network which is virtual and sits on top of one or more layers of other networks.

A system may include multiple servers 104a-c stored in high-density rack systems. If the servers are part of a common network, they do not need to be physically near one another but instead may be connected by a wide-area network (WAN) connection or similar connection.

Management of group of networked servers may be de-centralized. For example, one or more servers 104a-c may include modules to support one or more management services for networked servers including management of dynamic data, such as techniques for handling failover, data replication, and increasing the networked server's performance.

The servers 104a-c may be file servers, application servers, web servers, proxy servers, network appliances, gateways, gateway servers, virtualization servers, deployment servers, SSL VPN servers, or firewalls.

When the network 110 is in a cloud environment, the cloud network 110 may be public, private, or hybrid. Public clouds may include public servers maintained by third parties. Public clouds may be connected to servers over a public network. Private clouds may include private servers that are physically maintained by clients. Private clouds may be connected to servers over a private network. Hybrid clouds may, as the name indicates, include both public and private networks.

The cloud network may include delivery using IaaS (Infrastructure-as-a-Service), PaaS (Platform-as-a-Service), SaaS (Software-as-a-Service) or Storage, Database, Information, Process, Application, Integration, Security, Management, Testing-as-a-service. IaaS may provide access to features, computers (virtual or on dedicated hardware), and data storage space. PaaS may include storage, networking, servers or virtualization, as well as additional resources such as, e.g., the operating system, middleware, or runtime resources. SaaS may be run and managed by the service provider and SaaS usually refers to end-user applications. A common example of a SaaS application is SALESFORCE or web-based email.

A client 102a-c may access IaaS, PaaS, or SaaS resources using preset standards and the clients 102a-c may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

The clients 102a-c and servers 104a-c may be embodied in a computer, network device or appliance capable of communicating with a network and performing the actions herein. FIGS. 1A and 1B show block diagrams of a computing device 120 that may embody the client or server discussed herein. The device 120 may include a system bus 150 that connects the major components of a computer system, combining the functions of a data bus to carry information, an address bus to determine where it should be sent, and a control bus to determine its operation. The device includes a central processing unit 122, a main memory 124, and storage device 124. The device 120 may further include a network interface 130, an installation device 132 and an I/O control 140 connected to one or more display devices 142, I/O devices 144, or other devices 146 like mice and keyboards.

The storage device 126 may include an operating system, software, and a network user behavior module 128, in which may reside the network user behavior system and method described in more detail below.

The computing device 120 may include a memory port, a bridge, one or more input/output devices, and a cache memory in communication with the central processing unit.

The central processing unit 122 may be a logic circuitry such as a microprocessor that responds to and processes instructions fetched from the main memory 124. The CPU 122 may use instruction level parallelism, thread level parallelism, different levels of cache, and multi-core processors. A multi-core processor may include two or more processing units on a single computing component.

The main memory 124 may include one or more memory chips capable of storing data and allowing any storage location to be directly accessed by the CPU 122. The main memory unit 124 may be volatile and faster than storage memory 126. Main memory units 124 may be dynamic random access memory (DRAM) or any variants, including static random access memory (SRAM). The main memory 124 or the storage 126 may be non-volatile.

The CPU 122 may communicate directly with a cache memory via a secondary bus, sometimes referred to as a backside bus. In other embodiments, the CPU 122 may communicate with cache memory using the system bus 150. Cache memory typically has a faster response time than main memory 124 and is typically provided by SRAM or similar RAM memory.

Input devices may include smart speakers, keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include the same smart speakers, video displays, graphical displays, speakers, headphones, inkjet printers, laser printers, and 3D printers.

Additional I/O devices may have both input and output capabilities, including haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures.

In some embodiments, display devices 142 may be connected to the I/O controller 140. Display devices may include liquid crystal displays (LCD), thin film transistor LCD (TFT-LCD), blue phase LCD, electronic papers (e-ink) displays, flexile displays, light emitting diode displays (LED), digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays.

The computing device 120 may include a network interface 130 to interface to the network 110 through a variety of connections including standard telephone lines LAN or WAN links (802.11, T1, T3, Gigabit Ethernet), broadband connections (ISDN, Frame Relay, ATM, Gigabit Ethernet, Ethernet-over-SONET, ADSL, VDSL, BPON, GPON, fiber optical including FiOS), wireless connections, or some combination of any or all of the above. Connections may be established using a variety of communication protocols. The computing device 120 may communicate with other computing devices via any type and/or form of gateway or tunneling protocol such as Secure Socket Layer (SSL) or Transport Layer Security (TLS). The network interface 130 may include a built-in network adapter, network interface card, PCMCIA network card, EXPRESSCARD network card, card bus network adapter, wireless network adapter, USB network adapter, modem or any other device suitable for interfacing the computing device 120 to any type of network capable of communication and performing the operations described herein.

The computing device 120 may operate under the control of an operating system that controls scheduling of tasks and access to system resources. The computing device 120 may be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein.

The computer system 120 may be any workstation, telephone, desktop computer, laptop or notebook computer, netbook, tablet, server, handheld computer, mobile telephone, smartphone or other portable telecommunications device, media playing device, a gaming system, mobile computing device, or any other type and/or form of computing, telecommunications or media device that is capable of communication.

In all of the hardware systems mentioned above, the method and system described herein may be embodied in some form and perform the functions explained herein through software, programmed hardware, or other computing means. The method and system described herein may also be done with some steps in software, and others done by a user.

### 2 Illustrative Example

This section describes an example to introduce the key concepts of this system and method—uses hierarchy, function group, interactive facet selection, and facet clustering, to illustrate how to recover facet-related design structures interactively, and to demonstrate how facet clustering and the uses hierarchy can lead to insights on design quality.

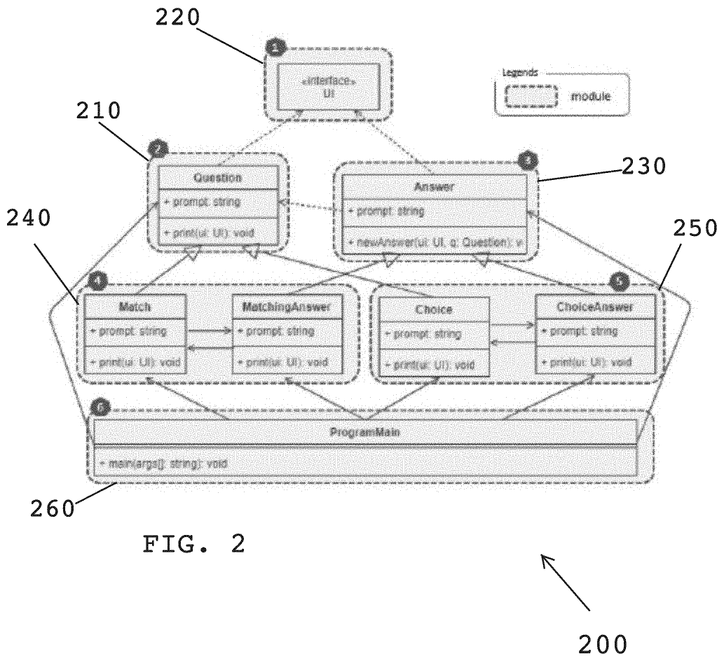

FIG. 2 depicts a partial UML class diagram 200 of a small questionnaire management system. This system allows a user to create a survey or a test, or to complete an existing survey or test. The system supports three types of questions: multiple-choice, matching, and essay shown in the question module 210, through which answers can be given via an answer module 230. The system was designed so that more types of questions can be easily added and evaluated in a question input module 240. A similar answer module 250 may evaluate answers and actions. The user interface 220 can be either console-based or file-based. In principle, of course, there could be many designs to achieve this functionality. The design shown in FIG. 2, reverse engineered from the source code—contains three abstract classes Question, Answer, and UI, as well as a main program 260, each having a set of sub-classes modeling different types of questions, answers, and user input formats. The system has 17 files in total; FIG. 1 only shows 8 of them for the sake of space.

### 2.1 Key Concepts

This system builds upon Parnas's notion of a uses hierarchy among modules, and adds to this the concepts of function group and facet clustering. Together these concepts can be used to recover facet-related design structures. Next, this disclosure introduces these concepts using the Questionnaire system as an example.

Uses hierarchy. Modules, defined as an independent task assignments, may form a uses hierarchy to ease the addition and removal of features and modules at a higher level in the hierarchy may only use lower-level modules. No existing architecture recovery method known to the inventors, however, is based on the rationale of recovering a uses hierarchy. Thus, the recovered information provides little insight into whether architecture is appropriately structured to ease the addition and removal of features.

A prior art clustering method called the design rule hierarchy (DRH), and a DRH-based recovery method was also proposed. A DRH clustering reveals key interfaces, independent modules formed by files, and their relations. DRH reveals the hierarchical relationships among files, but it does not reflect higherlevel (functional) modules. The classes in FIG. 2 form a DRH, in which the three abstract classes UI , Question, and Answer, each being a module, are at the top levels. Match and MatchingAnswer form a module because they depend on each other, which is at the same level in the hierarchy as the module formed by Choice and ChoiceAnswer. ProgramMain is the “entry class,” forming another module in the hierarchy. The 6 modules are within the labeled module boxes 210, 220, 230, 340, 350, 260 in FIG. 2. The method may further develop a DRH into a uses hierarchy formed by Function Groups.

Function Group. One possible first step is similar to DHR clustering: First, the method may reverse-engineer the source code into a directed graph in which the vertexes are the source files, and the edges model the dependency relations among source files. After that, the method may derive a condensation graph from this directed graph. Each vertex of a condensation graph is a strongly-connected component formed by a group of vertices from the original directed graph. For example, in FIG. 2, Match and MatchingAnswer depend on each other and thus form a strongly connected component. A condensation graph may be a directed acyclic graph (DAG), containing a partial ordering of the original graph. In a DAG, a vertex that depends on other vertices, but no vertex depends on it is defined as a minimal element, and all the files it depends on form a chain. All the files on the chain may be used by the minimal element to accomplish its function. For example, the minimal element in FIG. 2 is ProgramMain. It depends on all other files in the graph, directly, or indirectly. In other words, as the entry class of the system, it needs all other classes to implement its functionality.

Next, the method may form function groups based on this hierarchy. A function group may be defined as the set of files along the chain starting from a minimal element. The method may use the file name(s) of the minimal element as the name of the function group. In this example, Pro [symbol] ramMain is the first function group with all 8 files transitively aggregated.

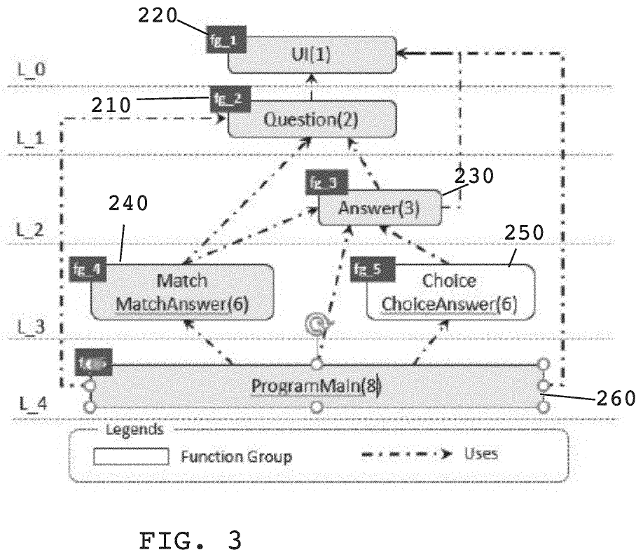

After that, the method removes the first minimal element and calculate other function groups recursively. In this example, if Pro [symbol] ramMain is removed, the updated DAG will then have two more minimal elements: (1) the module formed by Match and Matchin [symbol] Answer, and (2) the module formed by Choice and ChoiceAnswer . As a result, the method may obtain two more function groups. This process is repeated and 6 function groups are found in total, each having 8, 6, 6, 3, 2, 1 files respectively, as shown in FIG. 3.

FIG. 3 depicts the uses hierarchy divided between different use Levels L_0-L_4: each node is a function group, i.e, a set of files, and the edges model the “uses” relation among them. If a node f g_a “uses” another node f g_b, it means that the file set in f g_b is a subset of f g_a: f g_b⊂fg_a. This way, the method formalizes Parnas's uses hierarchy and it becomes possible to reverse-engineer such a hierarchy from source code. In this example, the method may tell how many functions are there and how smaller function modules are used by more complex functions, as shown in FIG. 3.

Interactive Facet Selection. It is conceivable that, even for a modest-sized project, the number of function groups could be huge. In the complete design of the questionnaire system, 17 source files formed 13 function groups. The better modularized the system is, the more such function groups can be found. Inspired by the work of others who proposed that each feature and each pattern can have its own design space and the fact that only the system stakeholders can know what the main features of the system are, or which cross-cutting facets they would like to have investigated, the method allows a user interactively enter the facets they care to investigate, and the system will output the uses hierarchy that is solely related to the selected facets, which the method calls a facet Hierarchy. In FIG. 3, all nodes 210, 220, 230, 240, 260 form a facet hierarchy related to the management of matching questions and answers.

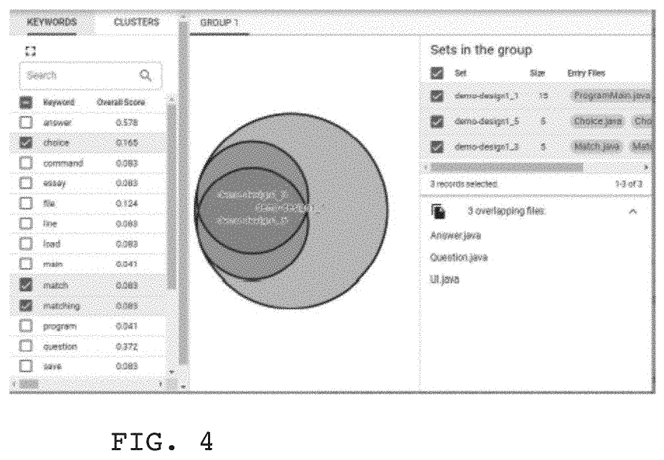

To link facets with design structures, the method may extract all the keywords from source code, present them to the user, and ask them to choose the keywords that are most related to a given facet. A working prototype2 enables the user to interactively choose the keywords that best reflect their facets of interest, as shown in FIG. 4. The left pane lists all the keywords that the user can choose from.

In this example, the method extracted 20 keywords from the 17 source files. Here the user-selected “choice” to represent the features of managing multiple-choice questions, and “match” and “matching” to represent the features of managing matching questions. The user can click the “Clusters” tab to examine these facet-related function groups, and how they overlap with each other using the visualization shown in the middle section. The upper-right panelists the three function groups involved in these two facets, and the bottom right pane lists the files that belong to all the selected function groups. In this figure, the method may see that all the function groups related to multiple-choice and matching questions use Answer.java, Question.java, and UI.java.

As an exploratory study, in this work the method only extracted keywords from file names, assuming the source files are named in a meaningful and regular way, e.g. following the camel case naming convention. It is possible to extract keywords from classes, methods, attributes, or even comments, but this is our future work.

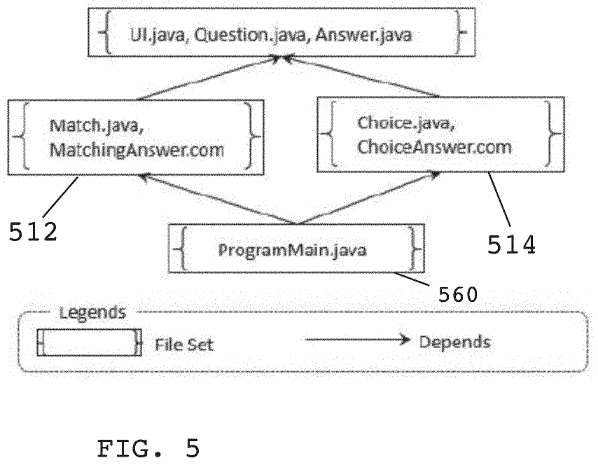

Facet Clustering. To review the design structure related to one or more facets, e.g, manifesting the key data models and abstractions needed to implement a feature, or the impact scope of a crosscutting concern, the method further expand a facet uses hierarchy into a facet clustering, a hierarchical graph as exemplified in FIG. 5.

Similar to ACDC clustering, bunch clustering, and DRH Clustering, the vertexes on a facet clustering are mutually exclusive file sets. FIG. 5 depicts a facet clustering formed by the uses hierarchies derived for two facets: multiple-choice 514 and matching 512 questions. This clustering makes it clear that both facets have to use the 3 shared classes, and are used by ProgramMain.java 560 and that each facet has their own separate file pairs.

### 2.2 Gaining Insights on Design Quality

The recovered uses hierarchy and facet clustering may help developers understand how each feature or facet is designed. This understanding will help them determine the key abstractions needed to implement a feature, or which functions related to multiple-choice questions, the developer can use these facet hierarchies to locate and diagnose the problem, dramatically narrowing down the search space. Furthermore, if a new developer would like to extend the system by adding a new type of question, they could use these hierarchies as a guide. Consulting the information provided the new question class may inherit or use the 3 common classes, and ProgramMain may need to be changed to accommodate the new question type.

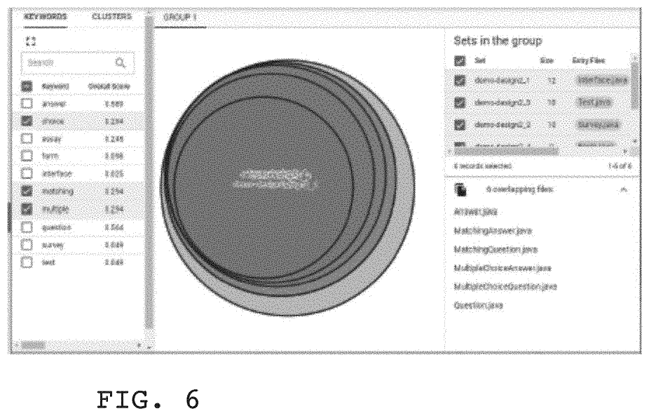

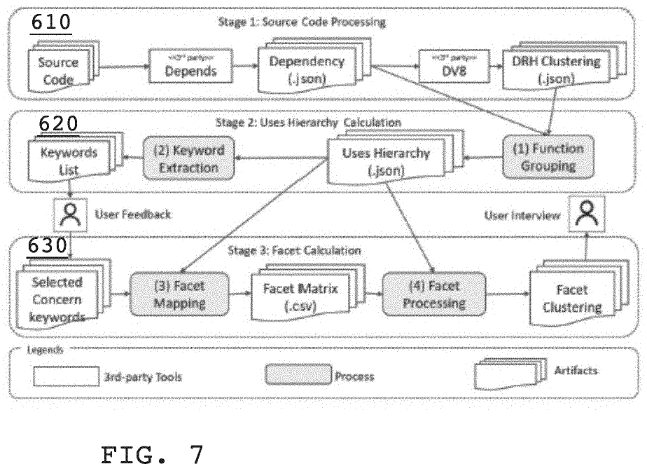

Another potential benefit of this approach is to assess design quality and diagnose design problems. Here the method uses a different design of the same system to illustrate. In the second design (reverse engineered from the source code written by a different developer), there are 12 source files, and our system found 7 function groups among the 12 files. As shown in FIG. 6, when the method choses the three keywords representing the same two facets (“multiple” and “choice” for multiple-choice questions, and “matching” for matching questions), 6 out of the 7 function groups are selected, involving 11 out of 12 files. As a matter of fact, choosing any question-related facets will end up involving 6 groups and 12 files, indicating that these facets are highly coupled.

After further examining this design, it becomes clear that it violates multiple design principles. For example, Question.java should be an abstract interface, but it was implemented as depending on every other sub-classes, violating the Liskov substitution principle. In addition, Form.java, which is used to tabulate answers, refers to all questions and answer sub-classes, violating the single responsibility principle. From the perspective of facets, the fact that all question-related facets return the same uses hierarchy indicates that these facets are not modularized as they should be. This analysis clearly illuminates the quality differences between these two designs and points to the existence of underlying design and implementation issues.

### 3 Approach

FIG. 6 depicts the three major stages of the method and system approach: 1) source code processing 610, 2) uses hierarchy calculation 620, and 3) facet calculation 630. The first stage processes the source code of a software system, and the 2nd stage calculates its uses hierarchy. After that, the user specifies the facets they care about. Given this user input, the third stage outputs facet clusterings that reveal how the selected facets were implemented, which is presented to the user for validation.

### 3.1 Source Code Processing 610

During this stage, the method may use two 3rd-party tools to pre-process the source code. The method may first use Depends3 to extract dependencies among files, and save the dependency information into a JSON file. After that, using the JSON dependency file as input, the method may use DV8 to generate a design rule hierarchy clustering among these files, and the method may save the clustering as another JSON file. These two files are the inputs to the next two stages.

### 3.2 Uses Hierarchy Calculation 620

This stage has the following two steps:

(1) Function Grouping. In this step, the method may extract function groups from a DRH clustering, which may contain multiple layers and each layer may contain multiple modules comprised of sub-modules or sub-layers. The method may recursively visit each layer and each module of the DRH clustering to collect all the minimal modules. For each module, the method iterates through dependencies to collect all the other files it depends on.

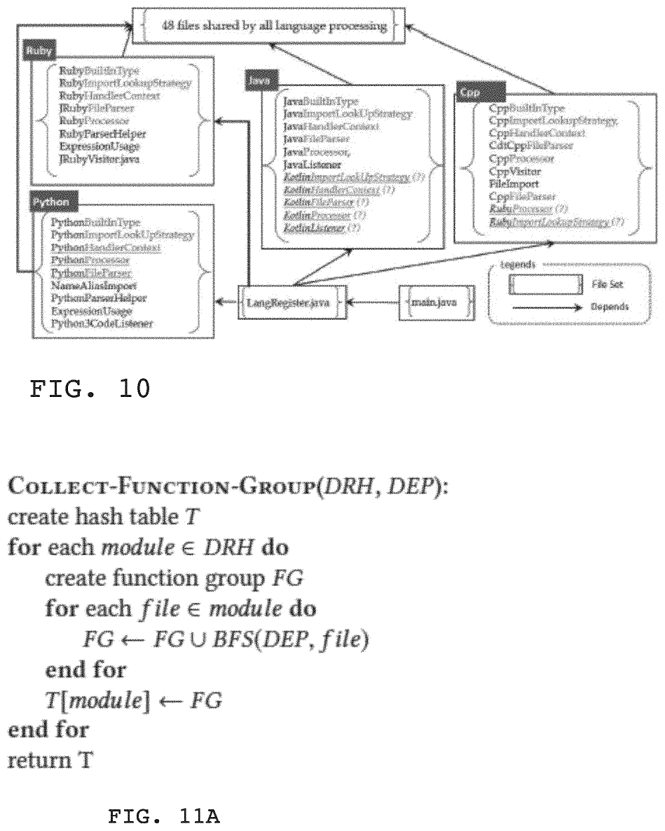

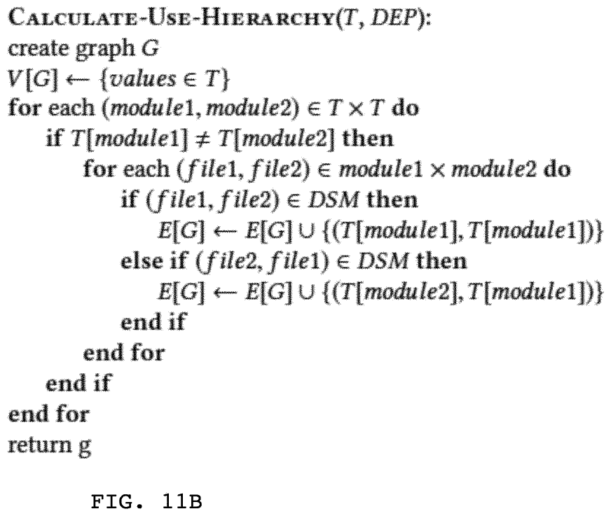

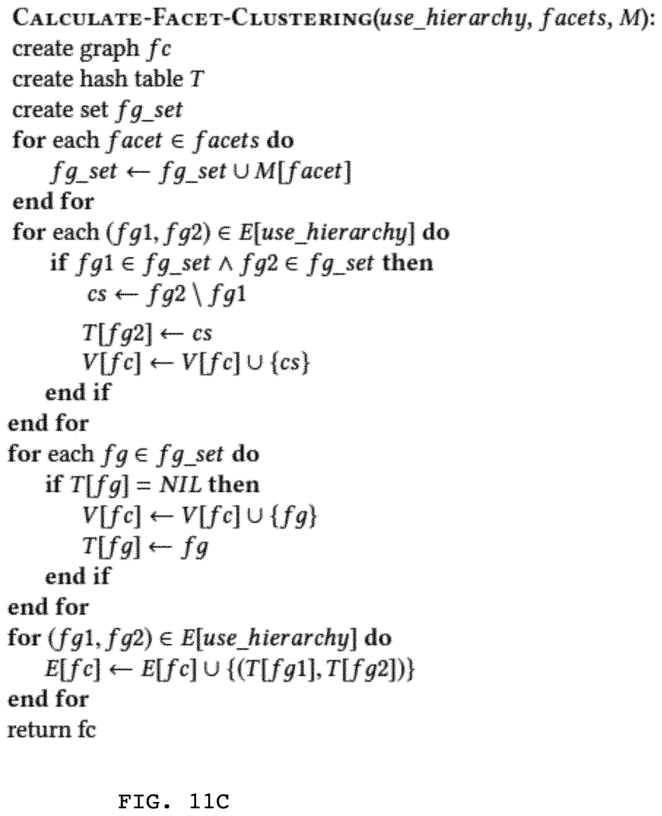

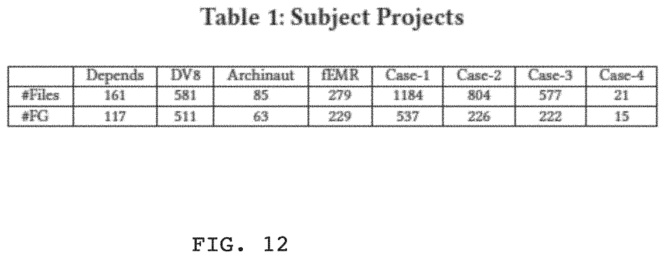

We may define the algorithm as follows. A function group is a set of files that contains 1) one or more leading files (files within a minimal element) collected from a DRH, and 2) all the ancestor files that leading files depend on. To collect a function group, the method may first collect files in a module node of a DRH, then for each file, the method may recursively traverse the dependency structure to find all its ancestor files. Each module in a DRH will generate one function group. The pseudo code shown in FIG. 11A shows the algorithm of collecting function groups. Here the method may use DRH clusterings and DEP dependency graph as input and use hash table T to store the mappings between modules and function groups. Since the dependency relation among files forms a graph, DEP, the method may use BFS to search all ancestor files in it.

A uses hierarchy is a DAG, where each vertex is a function group and each edge is a uses relationship. To calculate the uses hierarchy, the method may first examine all function groups collected and remove duplicated ones. Then the method may map the direct dependencies between DRH modules to the related function groups. In the pseudocode shown in FIG. 11B, the method may use hash table T and DEP graph as input and output a uses hierarchy graph G.

At this point, these function groups may form a uses hierarchy, in which a function group a at a higher level “uses” a function group b at a lower level, if b is a subset of a, and the files in a depend on files in b. This is different from other clustering-based architecture recovery results, such as ACDC, or Bunch, because these function groups are not mutually exclusive.

(2) Keyword Extraction. After the function groups are collected, the method may extract keywords from file names to generate a keyword set. For each file in a function group, the method may break the file name into meaningful words according to camel case conventions or underscore separators. For example, the method may convert “ChoiceAnswer.java” into “choice” and “answer.” In the inventors' case studies, the method may send this list to the users and ask them to mark the keywords that best reflect the facets.

### 3.3 Facet Calculation 630

Given the keyword list, there may be two ways the user can interact with the system. First, the user can use the I-FAR website to interactively select keywords that best reflect their facets, and visualize how function groups interact with each other as shown in FIG. 4 and FIG. 6. Second, for the user to analyze multiple facets or a category of facets, the method may provide a spreadsheet that enables them to mark the keywords for multiple facets, and our system returns a facet hierarchy and facet clustering in DOT format so that the user can examine them. The method may plan to fully automate this step in future work so that a user can make their choices and visualize the results from the website. The process of generating facet hierarchies and facet clustering has two steps:

(1) Facet Mapping. Given all the function groups and selected keywords for the facets, the method may first calculate the function groups related to each facet. For example, function groups 6 and 17 are related to the “choice” facet in the first Questionnaire design. At this point the method may form a facet matrix, in which one dimension is the set of keywords in the facets, the other is all of the function groups. Formally, a facet matrix is an m×m matrix where m is the number of facets and n is the number of function groups. Each cell of the matrix is a pair (facet, fg) which indicates function group fg is related to facet. For each function group fg, the method may check if it contains any keyword that belongs to a facet . If it does, the method may add a pair of (facet, fg) to the matrix.

(2) Facet Clustering Calculation. From a facet matrix, the user can choose one or more facets, and our system will return a facet clustering as shown in FIG. 4. A facet clustering is a hierarchical clustering, where the file sets in higher levels depend on the file sets in lower levels. The main difference is that the nodes (file sets) in a facet clustering are mutually exclusive. For example, in FIG. 5, the file set on the top contains 3 files that are shared by both facet “choice” and “matching.” The middle layer contains two file sets, each with files specific to respective facet, and the bottom layer contains the control file that uses all the files in other layers. Formally, facet clustering is a DRH-style DAG in which vertices are file sets and edges are dependencies. The method may use the actual code embodied in the pseudo code in FIG. 11C to calculate a facet clustering, which uses graph, use_hierarchy, facet list, facets, and facet matrix M as input, set fgs to store related function groups, hash table T to store mappings between function groups and facet file set, and output facet clustering graph f c. For each (fg1, fg2) pair in edges of use_hierarchy, fg1 is used by fg2.

### 3.4 Gaining Insights on Design Quality

One of the most well-known design principles is “Separation of Concerns.” Ideally, each facet should be designed and implemented separately. In reality, it is normal that multiple facets use similar sets of files, such as key interfaces or utility files. But if multiple facets always involve the same files—as was the case in the second design of the Questionnaire system described in Section 2—this means that these facets are not cleanly separated in source code. In this case, no matter what facet-related keywords the method choses, I-FAR returned a facet clustering with 11 out of 12 files, indicating that these facets are highly coupled. In our case studies, The inventors presented these facet clustering to the users (typically architects) and verified if there was a true design problem causing these facets to be coupled.

### 4 Case Studies

To explore the potential of interactive, facet-based architecture recovery approach, the inventors conducted case studies using 8 projects and interviewed 5 architects in charge of these projects. Our subjects include 2 open source projects, and 6 closed source projects, 4 of which are from the same multi-national corporation. In this section, the inventors introduce the subjects, describe the process of these case studies, and summarize the results.

### 4.1 Subjects

The inventors chose these 8 projects because their authors or chief architects are accessible and willing to provide their feedback to them. Two of the projects-Depends and DV8-are used in the I-FAR framework. We now briefly introduce each of these projects:

(1) Depends4: an open-source dependency extraction tool that can be used to extract dependencies among code entities.

(2) DV85: an architectural debt management tool that can detect architecture anti-patterns, quantify technical debts, and measure software maintainability. The inventors used the DRH clustering component of DV8 in our framework. DV8 in turn uses Depends to extract source code dependencies.

(3) fEMR6: an open-source electronic medical records system for transient medical teams formed to help people suffering from natural disasters where internet access is often not available.

(4) Archinaut [4]: a proprietary architecture analysis tool that aggregates multiple metrics from different tools, analyzes evolution trends, reveals hotspots, and enables the user to specify constraints among files.

(5) Four projects from a multi-national corporation, which the inventors call “Company” to keep its identity anonymous. The inventors name these projects Case-1, Case-2, Case-3, and Case-4.

Table 1 (FIG. 12) shows the number of files within each project (#Files) and the number of function groups I-FAR identified (#FG). Both Depends and Archinaut are designed and implemented by a single author. DV8 grew out of a research prototype developed by Ph.D. students, but is now written and maintained by professional developers. fEMR was developed by student volunteers as senior design projects from multiple universities. It is currently deployed and used by many medical teams around the world, and constantly seeks new developers to expand and add new features. Cases 1 to 4 are implemented by the company's internal development teams with 5 to 10 developers each.

### 4.2 Process

The case study includes the following 4 steps for each project: (1) data processing, (2) facet keyword selection by the users, (3) uses hierarchy and facet clustering generation, and (4) presentation, interview, and survey. This disclosure now elaborates on each step.

Step 1: Data processing. For the two open-source projects, the method first extracted the dependencies among source files using Depends and exported the dependency information into a JSON file. Using the JSON file as input, the method used DV8 to export a DRH clustering into another JSON file. For the other 6 projects, the inventors asked the architects to extract the dependency and clustering JSON files internally, and send these two files to us.

With these two JSON files, the method ran I-FAR to generate a uses hierarchy and a keyword list in the format of a .csv file, and listed the keywords in the I-FAR online interface, as shown in FIG. 4 and FIG. 6 for the users to choose from.

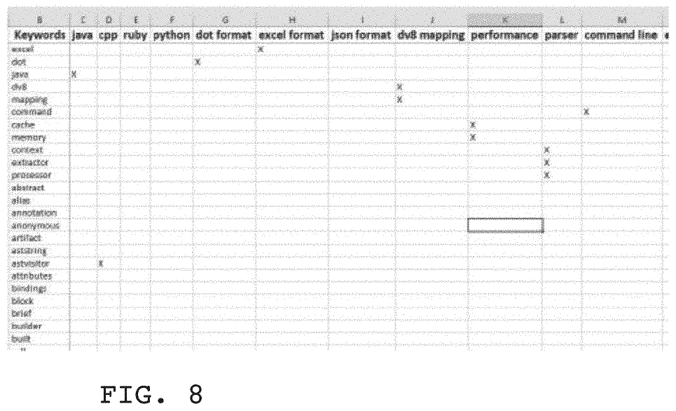

Step 2: Facet keyword selection. To allow the user to choose keywords related to multiple facets simultaneously, the inventors' method sent the keyword .csv file to each user and asked them to mark the keywords that best reflect 10-15 facets they care about. FIG. 8 shows a sample .csv file in which the architect of Depends listed the facets and marked corresponding keywords. For example, in the first row, columns C, D, E, F contain “java,” “cpp,” “ruby,” and “python” respectively, which are the 4 major languages that Depends can process, i.e., the main functions of the system. Columns H, I, J are labeled with the three file formats Depends can export the results to DOT, Excel, and JSON. The architect also marked their corresponding keywords in respective rows. Interestingly, the architect listed several crossing cutting concerns and their keywords. For example, the “Performance” concern is associated with “cache” and “memory.”

Step 3: Uses hierarchy and facet clustering generation. After receiving the marked keyword spreadsheets from the users, our first observation was that the facets listed by the architects could be naturally categorized into groups. For example, the architect of Depends listed 4 language facets for each of the 4 language processing functions, 3 facets for each of the 3 export file formats, and a few crossing concerns, including expression analysis, binding, dependency, detail dependency, dumper, and performance.

Similarly, the DV8 architect listed 6 architectural anti-pattern facets, each corresponding to one anti-pattern that it can detect, 3 metrics-related facets, 3 importing functions, 3 exporting functions, and 10 GUI-related functions, such as zoom-in/out and highlighting.

The main facets listed for Archinaut included: trend analysis—the function to show trends of measures over multiple versions; arch diff—the function of calculating score differences from one version to another; constraint-the function of specifying which files/folders shouldn't depend on which other files/folders, etc. The main fEMR facets are also its main functions, including triage-recording a patient's status and assigning doctors; trip-managing the information of locations the medical team is visiting; pharmacy-managing the location and inventory of local pharmacies, etc.

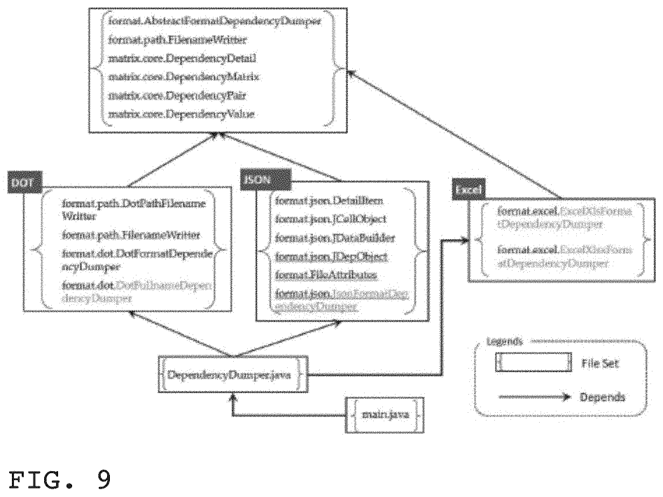

Using these .csv files as input, first the method calculated their uses hierarchies with all the function groups. After that, the method may calculate a uses hierarchy and facet clustering for each facet. Finally, for those facets of the same type, such as the 4 language facets in Depends, the method combined its use hierarchies and formed an integrated facet clustering, to reveal how similar types of functions or concerns are designed. FIG. 9 and FIG. 10 depicts two facet clusterings calculated from Depends' 3 exporting functions and 4 language processing functions respectively.

FIG. 9 depict the design structure related to exporting the dependency data to different file formats: DOT files that can be opened by Graphviz7, JSON format, and spreadsheet format. All file exporting functions may use the 6 files listed within the top box, which includes 4 core data model classes, one key abstraction class, and one utility class. Moreover, each file processing function may implement format-specific dependency dumpers and other format-related functions. Finally, all these functions influence DependencyDumper.java, which in turn influences main.java.

This design structure can serve as a reference for new contributors to Depends who would like to add another file exporting format, e.g, XML. The new contributor would know from this structure that the new functionality needs to use the 6 common classes, and must be used by DependencyDumper .java.

Similarly, FIG. 10 depicts the design structure related to language processing. All language processing involves 48 common files, including core data models, key abstractions, utility files, etc. In the I-FARwebsite, we have included a JSON file with these 48 files only that can be opened using DVB. It is also clear that whenever a new language needs to be processed, it has to be first registered using Lan [symbol] Re [symbol] ister .java.

Moreover, this clustering also reveals that each language processing function needs to have the following classes: a BuildInType, a ImportLookupStrategy, a HandlerContext, a FileParser, and a Processor.

The architect verified that these recovered design structures are useful, not only for him to explain the design of Depends to new contributors, but also useful for him to recall exactly how these features were designed (years ago). Most interestingly, these structures revealed several suspicious cases. For example, when “java” is entered as a keyword, 5 files related to Kotlin processing showed up in the facet uses hierarchy and clustering. When “cpp” is entered, the output clusterings contains two Ruby-related files. The method marked these files with “?” in FIG. 10. In these cases, it appears that these features are not properly separated. Ideally, the developers who maintain the processing of C++ programs should not worry about Ruby. The method presented these results back to the architect to get his opinion. The method also extracted the facet uses hierarchies for crosscutting concerns.

In Depends, the “cache” keyword returned 7 function groups in which only C++ processing is involved, while the “memory” keyword returned 53 function groups involving all language processing functions. When the inventors asked the architect why it is the case, he remembered and confirmed that only C++ programs need cache because they usually have a large number of header files that are resolved very slowly every time. Therefore, the architect added a cache function for C++ programs so that Depends doesn't need to resolve these header files repetitively. This is a design decision that was almost forgotten.

The method recovered similar design structures from all projects. Some of them revealed clear design structures for certain types of features. For example, for the 6 types of anti-patterns that DV8 detects, I-FAR revealed that the 6 function groups use 15 common files including core data structures and key abstractions, and are used by 6 other types of facets, including command-line user interface facets, graphical user interface facets, service facets, parameter setting facets, action facets, and issue progress facets. The method also find some strange couplings: When the method enters the keywords for one antipattern, function groups of other anti-patterns are returned. The inventors discussed this finding with the architect during their interview.

In some projects, such as Case-1 and Case-2, no matter which facet keywords were entered, I-FAR always returned the same uses hierarchy and facet clustering, involving a large number of files related to many other concerns and functions. The inventors suspect that these projects are not well modularized, and hence contain design debts that need to be addressed.

Next, this disclosure describes interaction with these architects to verify these observations.

Step 4: Presentation, interview, and survey. After calculating the facet hierarchy and clustering, the method may present these results to the architects and ask them to (1) verify whether the recovered design structures are consistent with their design; (2) comment on the suspicious findings, including the coupled functions that should have been separated, and why some facets are always coupled. After the interview, the method may email these architects the following questions:

Q1. Do you think the facet-related design structures recovered by I-FAR meaningful or useful to you? Please explain.

Q2. Do you think I-FAR helps understand how features are coupled with each other? Were these coupling expected or not?

Q3. Are there important concerns or features that do not match your expectations (in terms of files included or excluded)?

Q4. Does these reveal design improvement opportunities?

Q5. Do you think you could use I-FAR for future maintenance tasks, e.g., assessing the impact of a change, understanding how features and architectural concerns are implemented, etc?

Q6: Do you think I-FAR will help in explaining your system architecture and design to a new developer? Please explain.

Q7: Do you have any other comments?

The responses the received are summarized in the next section.

### 4.3 RESULTS

In this section, the method may present and summarize the answers received from the architects, and then present additional insights.

4.3.1 Survey Summarization. the method first categorizes the answers received into three groups: 1) the meaningfulness of the recovered design structure (Q1, Q2, Q3); 2) the revelation of design debts (Q4), 3) I-FAR's potential to inform maintenance activities (Q5, Q6), 4) other comments (Q7).

1. The usefulness of I-FAR recovery. The method asked the architects to comment on the general usefulness of I-FAR (Q1), and usefulness in terms of revealing expected or unexpected coupling (Q2 and Q3). Of the 5 architects interviewed, 4 of them strongly confirmed the value of I-FAR. Here are a few quotes: “Very valuable. In the longterm evolution, even as the original author, it is not possible to clearly remember the connections between some design elements. For example, why DependencyDumper is connected with all other format-specific Dumper classe, why PlantUmlDumper uses DependencyType, while other Dumpers do not.”—Depends. “Yes, it's absolutely meaningful in some real engineering scenarios. For example, both junior/senior developers would quickly understand the code architecture that is concern-related when specific clues are given, like keywords searching supported by I-FAR, the interactive tool with which developers can get real feature requests done more efficiently, means more value to engineering than build an overview of architecture.”—DV8. “Yes. It helps to identify and visualize the risks associated with introducing change into a complex system.”—fEMR. “Yes. It reveals what are the core components that should be maintained more carefully.”—Company.

2. The identification of design debts. All architects discovered design debts from I-FAR output that need to be addressed. the inventors have mentioned the debts confirmed by the architects of DV8 and Depends. The Depends architect also commented: “There are some improvement opportunities, for example, Python's design elements don't match other design elements, and there is an unnecessary coupling between Cpp and Ruby. The relationship between Inferer and Entity looks to be unnecessarily complex.” From Archinaut: “From the questions that were given to me, the dependency between Design-StructureMatrix and ArchitectureDiff is indeed suspicious . . . I know why it is there, but it should probably be extracted.,” “The fact that a view depends on a controller and a controller on several services is expected. However, the fact that TrendsAnalysisView depends on DesignStructureMatrixViewController is a bit surprising, it should only depend on TrendsAnalysisViewController.” For the other projects, the architects all confirmed that I-FAR revealed the existence of design debt. However, due to a large number of coupled features, they are not able to identify concrete suspicious dependencies as easily as with Depends, DV8, and Archinaut, which suggests the need for further automation.

3. Potential to inform future maintenance activities. Here the method aims to understand if the architects could use I-FAR to guide or inform maintenance (Q5) and to introduce their designs to new developers (Q6).

For Q5, the architects generally confirmed that I-FAR could aid in maintenance tasks. “Visibility provided by I-FAR is valuable for understanding the risk and impact of any proposed changes.”—fEMR.

4.3.2 Additional Insights. In addition to this feedback, the inventors also made a few interesting observations. First, the inventors observed that the number of function groups generally reflected the level of modularity. For example, in DV8, I-FAR identified 511 function groups from 581 files of DV8, and 117 function groups from 161 files of Depends, indicating that most files followed the single responsibility principle.

In such a system, facets are more likely to have distinctive facet hierarchies and facet clusterings, and it is easier for the architects to discern suspicious coupling and identify design debts. At the other extreme, in Case-1, Case-2, and Case-3, the ratios between #FG and #Files are less than 50%. In these cases, the inventors cannot reliably distinguish separable facets because most facet related keywords returned almost the same hierarchy and clustering.

For these projects, it is difficult to figure out why these facets are grouped without further automated analysis. The other projects, fEMR, Archinaut, and Case-4, are in the middle. For example, in fEMR, of the 11 facets the users specified, 6 of them have distinctive uses hierarchies and clusterings. It appears that the less modularized the system is, the less useful the current I-FAR output is.

This observation suggests the possibility of using the ratio between the number of function groups and the number of files to indicate modularity levels. It also suggests that a user should use IFAR early in the development process, and detect suspicious design debts early before they become more severe.

It is worth noting that, for systems that are not severely decayed, the design debts the inventors identified cannot be detected by existing tools. For example, the issue type enumeration file in DV8, and these files with suspicious or forgotten dependencies identified in fEMR, Depends, Archinaut, and Case-4, do not exhibit code smells, DV8 anti-patterns, or other currently detectable flaws. But all architects admit that they present potential risks in future maintenance.

4.3.3 Summary. In summary, I-FAR provides a unique architecture recovery approach that is most useful in projects where design debts are starting to emerge and accumulate. In these cases, I-FAR could be used to detect suspicious dependencies that improperly or accidentally couple multiple features and functions, violating the single responsibility principle. It is important to emphasize that in such projects these early debts do not have code or design smells, and hence are not detectable by other technical debt detection tools. For example, none of the flawed files the inventors mentioned so far are God classes, have clones, or have cyclical dependencies. They are uniformly quite small and do not participate in cyclic dependencies.

### 5 Related Work

The I-FAR framework is unique and mostly related to research on dependency-based architecture recovery and feature localization.

Dependency-based architecture recovery. As mentioned above, architecture recovery research aims to recover views of software architecture from source code or execution traces. Each method has a different rationale. Methods such as WCA and Limbo use file dependencies as input and generate hierarchical clusterings based on similarities between file groups. ACDC clusters files based on naming patterns. Bunch uses hill-climbing algorithms to cluster files based on coupling and cohesion. Recovering architecture from a DRH clustering has also been proposed.

All these existing architecture-recovery approaches output mutually exclusive file sets, while our I-FAR calculates uses hierarchy. I-FAR also leverages interactive keyword selection and outputs facet-related uses hierarchy and clustering. I-FAR appears to be the first and only approach that recovers uses hierarchy, as proposed by Parnas, from source code.

Feature Localization. Feature localization aims to locate code that implements some functionality in a software system. There are two categories of feature localization: static analysis and dynamic analysis. The current approach is more similar to static analysis methods. These methods involve traversing dependency graphs of code and relying on developers' input to mark code. The biggest difference between this work and that work, however, is that the method herein uses file-level dependencies to recover a higher-level abstraction, rather than fine-grained function or keyword dependencies.

I-FAR is the only approach that enables the analysis of multiple facets of the same type to reveal their common design structures. Moreover, the inventors use the term facet rather than feature or concern because the latter two terms are overly used, and there is no rigorous definition of feature or concern, nor rigorous distinction between them. Given the complex nature of software, a facet can be either a feature, a function, a concern, or any aspect of interest.

While the invention has been described with reference to the embodiments above, a person of ordinary skill in the art would understand that various changes or modifications may be made thereto without departing from the scope of the claims.

1. A system for recovering programming architecture from source code, comprising:
source code processing, wherein the first stage processes the source code of a software system;
uses hierarchy calculation, wherein calculates its uses hierarchy; and
facet calculation, wherein the system outputs facet clusterings that reveal how the selected facets were implemented.

2. The system of claim 1, wherein during system processing, in a first stage, a program extracts dependency between files and saves the dependency information into a JSON file, and in a second stage, a program generates a design rule hierarchy clustering among these files and saves the clustering as another JSON file.

3. The system of claim 2, wherein during hierarchy calculation, the system extracts function groups from a DRH clustering, which may contain multiple layers and each layer may contain multiple modules comprised of sub-modules or sub-layers, wherein the system recursively visits each layer and each module of the DRH clustering to collect all the minimal modules and for each module, the system iterates through dependencies to collect all the other files it depends on.

4-5. (canceled)
